(19) United States
(12) Patent Application Publication
(10) Pub. No.: US 2025/0190634 A1
(43) Pub. Date: Jun. 12, 2025

(54) PROVIDING PACKET INTEGRITY PROTECTION FOR A COMMUNICATION PATH THAT INCLUDES A NON-TRANSPARENT BRIDGE

(71) Applicant: Microchip Touch Solutions Limited, Wokingham (GB)

(72) Inventors: Richard Jonathan Petrie, Guildford (GB); Roja Annem, Leander, TX (US)

(21) Appl. No.: 18/973,051

(22) Filed: Dec. 8, 2024

Related U.S. Application Data
(60) Provisional application No. 63/608,003, filed on Dec. 8, 2023.

(51) Int. Cl. G06F 21/85; G06F 13/40; G06F 13/42

(52) U.S. Cl. CPC G06F 21/85; G06F 13/4022; G06F 13/4282; G06F 2213/0026

(57) ABSTRACT

A method may include protecting integrity of a first segment of a communication path across different PCIe domains with a first integrity code, the different PCIe domains connected by a non-transparent bridge; and protecting integrity of a second segment of the communication path with a second integrity code, wherein the second integrity code is different than the first MAC.

### PRIORITY CLAIM

This application claims the benefit under 35 U.S.C. § 119 (e) of U.S. Provisional Patent Application Ser. No. 63/608,003, filed Dec. 8, 2023, the disclosure of which is hereby incorporated herein in its entirety by this reference.

Examples include providing packet integrity protection of a communication path that includes a non-transparent bridge (NTB) connecting different PCIe domains of a network, and PCIe devices that implement the same.

### BACKGROUND

Integrity checks are used in a variety of security and other applications for Peripheral Component Interconnect Express (PCIe) switches.

### BRIEF DESCRIPTION OF THE DRAWINGS

To easily identify the discussion of any particular element or act, the most significant digit or digits in a reference number refer to the figure number in which that element is first introduced.

FIG. 1 is a swim-lane diagram depicting a process to provide packet integrity protection across different PCIe domains of a network connected by an NTB (e.g., bridged by a PCIe switch in NTB mode, without limitation), in accordance with one or more examples.

FIG. 2 is a swim-lane diagram depicting a process to provide packet integrity protection across different PCIe domains of a network connected by an NTB (e.g., bridged by a PCIe switch in NTB mode, without limitation), in accordance with one or more examples.

FIG. 3 is a swim-lane diagram depicting a process to provide packet integrity protection across different PCIe domains of a network connected by an NTB (e.g., bridged by a PCIe switch in NTB mode, without limitation), in accordance with one or more examples.

FIG. 4 is a schematic diagram of a packet structure that includes a field (or subfield) for a first integrity code and a field (or subfield) for a second integrity code, in accordance with one or more examples.

FIG. 5 is a schematic diagram of a packet stream structure that includes fields for a first integrity code and a second integrity code utilized to protect information in the integrity-protected portions of multiple packets in sequence (e.g., a stream, without limitation), in accordance with one or more examples.

FIG. 6 is a schematic diagram of a system for providing packet integrity protection of a communication path that includes a non-transparent bridge (NTB), in accordance with one or more examples.

FIG. 7 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In the context of PCI Express (PCIe) switches, transparent bridge mode and non-transparent bridge mode are two distinct operational modes that may be offered by a PCIe switch (a PCIe switch may offer one or both of these modes) that functions as a bridge between devices in the same or different domains or partitions (hereafter term “domain” refers to both domains and partitions unless otherwise stated or the context in which it is used would indicate otherwise to a person having ordinary skill in the art). These modes affect how the PCIe switch handles routing PCIe traffic (e.g., PCIe packets, without limitation) and the switch's visibility within the PCIe network. Here, “visibility” refers to whether a switch appears as a distinct entity to other devices (e.g., host devices recognize the presence of a bridge and are aware they are communicating with a bridge, without limitation), or operates in a manner that makes it effectively invisible (e.g., host devices perceive direct communication with each other and are unaware of the bridge, without limitation).

In transparent bridge (TB) mode, a bridge (here, the PCI switch in transparent bridge mode) connects PCIe devices within a same domain, and behaves as if it is invisible in a communication path between the PCIe devices. The connected devices are unaware of the bridge as a distinct entity. Devices connected to the transparent bridge perceive their communication as if they are within a same domain, without any intermediaries, even though the bridge is present. A transparent bridge does not modify the packet headers (or other information used for route determination) in a packet. The PCIe switch forwards packets without modifying packet headers (or other information used for route determination), maintaining standard PCIe addressing and routing protocols.

In non-transparent bridge (NTB) mode, the bridge (here, the PCI switch) partitions the PCIe network into different domains (e.g., two or more distinct domains, without limitation) and connects PCIe devices across the different domains. The connected devices recognize the NTB as a distinct entity intermediating between the different domains. The NTB manages communication across PCIe domains, which may include changing packet headers (e.g., address information or other information (e.g., metadata, without limitation) used to determine routing information, without limitation) in a packet. NTB mode enables scenarios such as multi-host communication and resource sharing while isolating domains for security or functional purposes.

Integrity protection involves providing assurances that a message originates from a specific, authenticated source and remains unaltered during transmission (e.g., that the message has not changed during transmission, without limitation). Such assurances are sometimes achieved by including a piece of information (e.g., a cryptographic hash, without limitation) that can be used to authenticate a message and verify its integrity (e.g., determine whether or not the message has changed, without limitation).

In PCIe, a Message Authentication Code (MAC) can be used for secure data transmission. For example, the Advanced Encryption Standard (AES), a symmetric encryption algorithm, can generate an integrity code based on input information (e.g., a cryptographic key, password, or specific portions of the packet such as encrypted or integrity-protected sections, without limitation). If both sender and receiver know the AES algorithm and the shared input information, they can independently generate the same integrity code. If the integrity-protected portion of the packet is altered during transmission, the receiver's computed integrity code will not match the one included with the packet, indicating tampering or errors.

In NTB mode, a bridge (e.g, a PCIe switch operating in NTB mode, without limitation) may change portions of a packet, such as information in an integrity-protected portion of a packet such as address information or other information used to determine routing information, without limitation. Such changes invalidate the original integrity code, rendering standard end-to-end integrity checks ineffective. Thus, packet integrity protection across different PCIe domains requires alternative approaches to maintain security without relying solely on traditional end-to-end MAC validation.

One or more examples relate, generally, to packet integrity protection in a communication path that includes a non-transparent bridge (NTB) (e.g., a PCIe switch.

In one or more examples, a packet format includes two or more fields (or subfields) for respective integrity codes (e.g., MACs, without limitation). The first integrity code validate (e.g., is used to check, without limitation) the integrity of a segment of the communication path between a first device (e.g., an originating device, without limitation) and a non-transparent bridge (e.g., a PCIe switch in NTB mode, without limitation), and the second integrity code validates the integrity of a segment of the communication path between the NTB and the second device (e.g., a destination host, without limitation). The first and second integrity codes may be stored in respective fields of the packet, according to the packet format.

The first integrity code is determined and generated by a first device (e.g., the originating device, without limitation). The first device determines the first integrity code based on the contents of the integrity-protected portion of a packet (e.g., the information in an integrity-protected portion of the packet, without limitation) it provides to the NTB.

The second integrity code is also determined and generated by the originating device. The first device determines the second integrity code based on expected modified contents of the integrity-protected portion of the packet after processing by the NTB. More specifically, based on the expected information in the integrity-protected portion of the packet when the NTB provides it to the second device.

In one or more examples, the first device determines the expected contents of the packet post-processing by the NTB based on details about modifications the NTB will make to the packet during processing. In one or more examples, the NTB may provide all of the details to the first device. Alternatively, in one or more examples the NTB may provide some of the details to the first device and the first device may be aware of other details. In one or more examples, the details may be or include information about one or more of: actions, modifications to contents, or delivery path (“delivery path information” or “path information”).

Here, “path information” refers to details about a packet's end-to-end delivery, including any changes (e.g., transformations, translations, or other modification, or rules for performing the same, without limitation) to the packet along a route. Path information includes information the NTB would use to determine a packet's route and/or determine changes to an integrity-protected portion of a packet. For example, an NTB may provide path information that includes address information and/or routing information to the first device and the first device may determine modifications to the integrity-protected portion of a packet based on the received path information and optionally its knowledge of how the NTB will modify the packet's contents during forwarding and the path information. Here, “routing information” refers to logic and information used to determine how packets are routed. Some routing information may be at least partially determined based on information in packet headers such as address information. Logic may include, as non-limiting examples, rules for address translations, forwarding, or packet modifications.

In one or more examples, a non-transparent bridge receives the packet including the first integrity code and the second integrity code. Upon receiving the packet, the NTB verifies the first integrity code to ensure the integrity of the first segment. If the first integrity code is verified, the NTB may, in one or more examples, change the information in the integrity-protected portion of the packet (e.g., based on path information such as address information or routing information, without limitation) and sends (e.g., forwards, without limitation) the packet to the second device, the sent packet including the first integrity code and the second integrity code. Alternatively, if the first integrity code is verified, the NTB may, in one or more examples, change the information in the integrity-protected portion of the packet, write the second integrity code to the field for the first integrity code, and send the changed packet with the second integrity code (but not the first integrity code) to the second device.

In one or more examples, the path information can be requested by the first device, from the NTB and sent via a secure connection between the first device and the bridge. The secure connection ensures the confidentiality, integrity, and authenticity of the path information being received. In one or more examples, such a secure connection may be implemented as part of the first segment using PCIe-defined security mechanisms (e.g., PCIe Integrity and Data Encryption (IDE), without limitation) or encryption and integrity may be applied at the PCIe transaction layer; or the secure connection may be implemented as a separate logical channel over a sideband interface or management network.

In one or more examples, the NTB is a PCIe switch in a non-transparent bridge mode of operation. In one or more examples, the PCIe switch may offer only non-transparent bridge mode, or may offer both transparent bridge mode and non-transparent bridge modes.

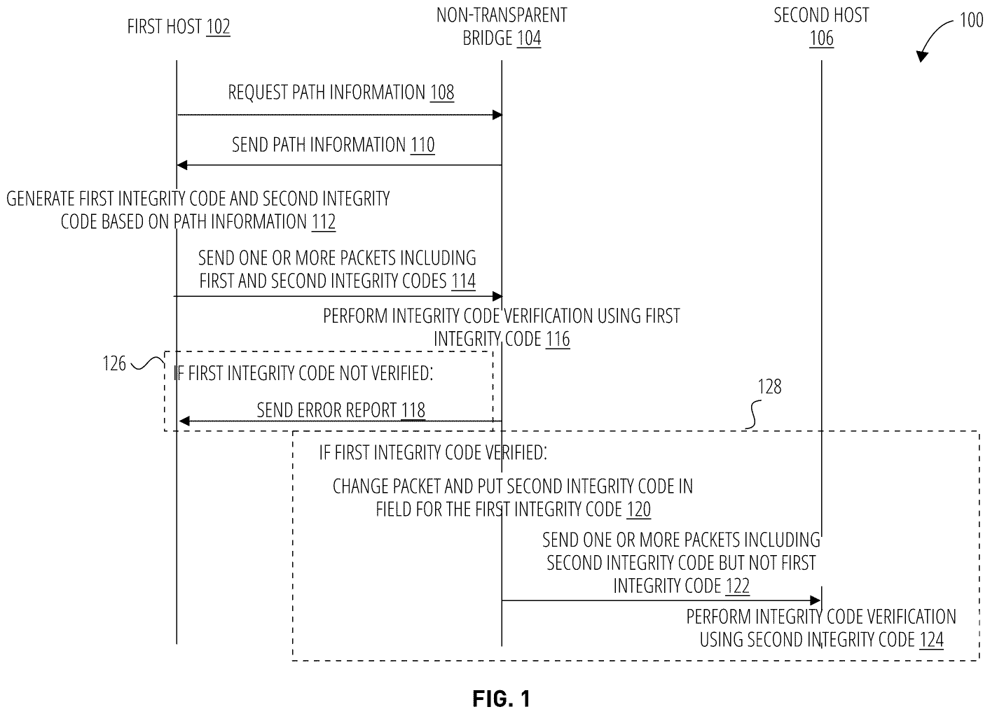

FIG. 1 is a swim-lane diagram depicting a process 100 to provide packet integrity protection across different PCIe domains connected (e.g., interfaced, without limitation) by an NTB (e.g., bridged by a PCIe switch in NTB mode, without limitation), in accordance with one or more examples.

Although the example process 100 depicts a particular sequence of operations, the sequence may be altered without departing from the scope of the present disclosure. For example, some of the operations depicted may be performed in parallel or in a different sequence that does not materially affect the function of the process 100. In other examples, different components of an example device or system that implements the process 100 may perform functions at substantially the same time or in a specific sequence.

The system that performs process 100 depicted by FIG. 1 includes a first host 102, an NTB 104, and a second host 106. In one or more examples, first host 102 and second host 106 may be, as non-limiting examples, host devices, or root complex logic of host devices, without limitation. In one or more examples, NTB 104 may be a PCIe switch operating in non-transparent bridging mode. The NTB divides the network into two domains: a first domain including the first host 102 and the NTB 104, and a second domain that includes the NTB 104 and the second host 106.

In one or more examples, process 100 may include first host 102 requesting path information from NTB 204 at operation 108. The path information is utilized to determine how the NTB will modify the integrity-protected portion of the packet and generate a second integrity code based on the determined modifications. The path information may include one or both address information or routing information. In one or more examples, first host 102 may initiate a path information request to the NTB 104. Such a path information request may be formatted, as non-limiting examples, as a control packet or a management command that conforms to PCIe standards.

In one or more examples, process 100 may include NTB 104 sending path information to first host 102 at operation 110. The requested path information may include, as non-limiting examples, one or more of: address translation rules that specify how the NTB 104 maps addresses from the first host's domain to the second host's domain, modifications that detail changes the NTB will apply to the header or payload of a packet (e.g., to routing fields of the packet, without limitation), or domain-specific identifiers that ensure packets are forwarded correctly across the different PCIe domains.

In one or more examples, NTB 204 may determine path information at least partially based on information in or more of: routing tables, address translation tables, configuration space data, or vendor-defined logic or extensions, respectively stored at NTB 204.

The path information may include one or more of: information used to change information in the integrity-protected portion of a packet, and information about how NTB 204 will change information in the integrity-protected portion of the packet. In one or more examples, information in the integrity-protected portion of the packet that the NTB 204 changes may include information in the header.

In one or more examples, communication of one or both of operation 108 and operation 110 may be performed via a secure connection. In one or more examples, such a secure connection may be implemented as part of the first segment using PCIe-defined security mechanisms (e.g., PCIe Integrity and Data Encryption (IDE), without limitation) or encryption and integrity may be applied at the PCIe transaction layer; or the secure connection may be implemented as a separate logical channel over a sideband interface or management network.

In one or more examples, process 100 may include the first host 102 generating first integrity code and second integrity code at least partially based on the path information received from the NTB 104 at operation 112. Any suitable technique (e.g., a PCIe native or non-PCIe native cryptographic or hash-based methods, without limitation) based on specific operating conditions may be utilized to determine the first and second integrity codes. Non-limiting examples including Advanced Encryption Standard (AES) MACs, AES-GCM tags, a hash-based MAC, or a key derivation technique, without limitation.

In one or more examples, process 100 may include sending one or more packets including the first integrity code and the second integrity code at operation 114. In one or more examples, a single packet may include the first second integrity code and the second integrity code and the integrity codes may protect information in the integrity-protected portion of the single packet. Additionally or alternatively, a single packet may include the first second integrity code and the second integrity code, and the first second integrity code and the second integrity code may protect information in the integrity-protected portions of multiple packets in sequence (e.g., a stream, without limitation).

In one or more examples, process 100 may include NTB 104 performing integrity code verification using the first second integrity code at operation 116.

Block 126 relates to a case where the first integrity code is not verified. If NTB 104 does not successfully verify the first integrity code at operation 116, then in one or more examples, process 100 may include NTB 104 sending an error report to first host 102 (or to the source port) at operation 118. The error report may indicate that verification of the first integrity code failed and so there may be a problem with the segment of the communication path between first host 102 and NTB 104 (i.e., a problem with the first segment). Any suitable action may be taken by first host 102 upon notification that verification of the first integrity code failed, depending on specific operation conditions. Additionally or alternatively, the NTB 104 may send the error report to the second host 106 (or to the destination port). So, in one or more examples, NTB 104 may send an error report to the source port or to the destination port, and may indicate that packet has been tampered by setting control information associated with the packet such as asserting a tamper bit.

Block 128 relates to a case where the If NTB 104 does successfully verify the first integrity code at operation 116, then, in one or more examples, process 100 may include NTB 104 putting second integrity code in a field for the first integrity code at operation 120, e.g., overwriting the first integrity code with the second integrity code.

Further, NTB 104 may change the one or more packet received from first host 102. The change may include a change to the information in integrity-protected portion of the one or more packet. The change me be at least partially based on the some or a totality of the path information provided to first host 102 at operation 110. As a non-limiting example, NTB 104 may change information in an address subfield of a header. A first address of a first partition may be replaced with a second address of a second partition. By way of non-limiting example, NTB 104 may include a look-up-table (LUT) that uses addresses of the first partition as an index to search for, and provide, addresses of the second partition.

In one or more examples, process 100 may include the NTB 104 sending one or more packets including second integrity code, but not the first integrity code, to second host 106 at operation 122.

In one or more examples, process 100 may include second host 106 performing integrity code verification using the second integrity code at operation 124. Notably,

In one or more examples, second host 106 does not need to be aware of the first integrity code generated by the first host 102, or be aware of the field for the second integrity code in the packet. It utilizes the second integrity code stored in the field originally for the first integrity code. So, in one or more examples, second host 106 may be a PCIe host that is not aware of the first integrity code generated by the first host 102 or a field for the second integrity code in the packet, or a PCIe host that is aware of the first integrity code generated by the first host 102 or a field for the second integrity code and can use the second integrity code now stored in both fields.

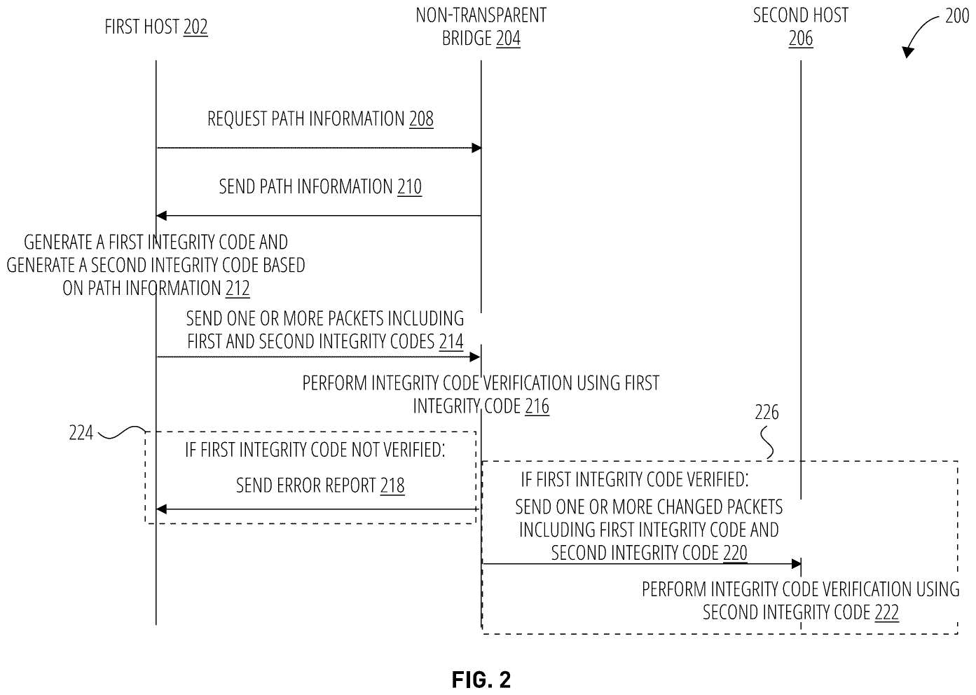

FIG. 2 is a swim-lane diagram depicting a process 200 to provide packet integrity protection across different PCIe domains connected (e.g., interfaced, without limitation) by an NTB (e.g., bridged by a PCIe switch in NTB mode, without limitation), in accordance with one or more examples.

Although the example process 200 depicts a particular sequence of operations, the sequence may be altered without departing from the scope of the present disclosure. For example, some of the operations depicted may be performed in parallel or in a different sequence that does not materially affect the function of the process 200. In other examples, different components of an example device or system that implements the process 200 may perform functions at substantially the same time or in a specific sequence.

The system that performs process 200 depicted by FIG. 2 includes a first host 202, an NTB 204, and a second host 206. In one or more examples, first host 202 and second host 206 may be, as non-limiting examples, host devices, or root complex logic of host devices, without limitation. In one or more examples, NTB 204 may be a PCIe switch operating in NTB mode. NTB 204 divides a network into two domains: a first domain that includes the first host 202 and the NTB 204, and a second domain that includes the NTB 204 and the second host 206.

In process 100 after verifying the first integrity code, the NTB modifies the packet and replaces the first integrity code with the second integrity code before forwarding the modified packet to the second host. In process 200, after verifying the first integrity code, the NTB modifies the packet but forwards it with both the first integrity code and the second integrity code intact to the second host. So, in process 200, the NTB retains both the first and second integrity codes, as non-limiting examples, for scenarios where the second host might need visibility into both integrity checks (e.g., for debugging, auditing, or extended security protocols, without limitation). Unless explicitly stated otherwise, operations in process 200 carry the same description as similar operations in process 100.

In one or more examples, process 200 may include first host 202 requesting path information from NTB 204 at operation 208.

In one or more examples, process 200 may include NTB 204 sending path information to first host 202 at operation 210.

In one or more examples, process 200 may include first host 202 generating a first integrity code and a second integrity code based on path information at operation 212.

In one or more examples, process 200 may include first host 202 sending one or more packets including the first integrity code and second integrity code to NTB 204 at operation 214.

In one or more examples, process 200 may include performing integrity code verification using the first integrity code at operation 216.

Block 224 relates to a case where integrity code verification was not successful. If the integrity code verification was not successful then, in one or more examples, process 200 may include NTB 204 sending an error report to first host 202 (or source port) at operation 218. Additionally or alternatively, the NTB 104 may send the error report to the second host 106 (or to a destination port). So, in one or more examples, NTB 104 may send an error report to the source port or to the destination port, and may indicate that packet has been tampered by setting control information associated with the packet such as asserting a tamper bit.

Block 226 relates to a case where integrity code verification of the first integrity code was successful. If the integrity code verification of the first integrity code was successful then, in one or more examples, process 200 may include NTB 204 sending one or more packets—which include both the first integrity code and the second integrity code-to second host 206 at operation 220. As discussed, above, the packet sent by NTB 204 in operation 220 is a modified packet, where the integrity-protected portions (i.e., that were protected by the first integrity code) have been changed as required (e.g., to reflect address translation or routing information, without limitation). The modifications to the integrity-protected portions are performed by the NTB 204 based on its routing logic, and the changes should align with the determination by the first host 202 based on which it generated the second integrity code.

In one or more examples, process 200 may include second host 206 performing integrity code verification using the second integrity code at operation 222. In one or more examples, second host 206 may, or may not be, aware of the first integrity code or the field for the second integrity code in the packet. Even if aware of the first integrity code, second host 206 may perform integrity code verification (end-to-end integrity verification) using the second integrity code but not the first integrity code.

In one or more examples, an NTB may process a packet without performing integrity code verification. The first host determines an end-to-end integrity code at least partially based on the path information provided by the NTB and stores the end-to-end integrity code in a field of the packet. The second host (destination device) performs integrity code verification using the end-to-end integrity code.

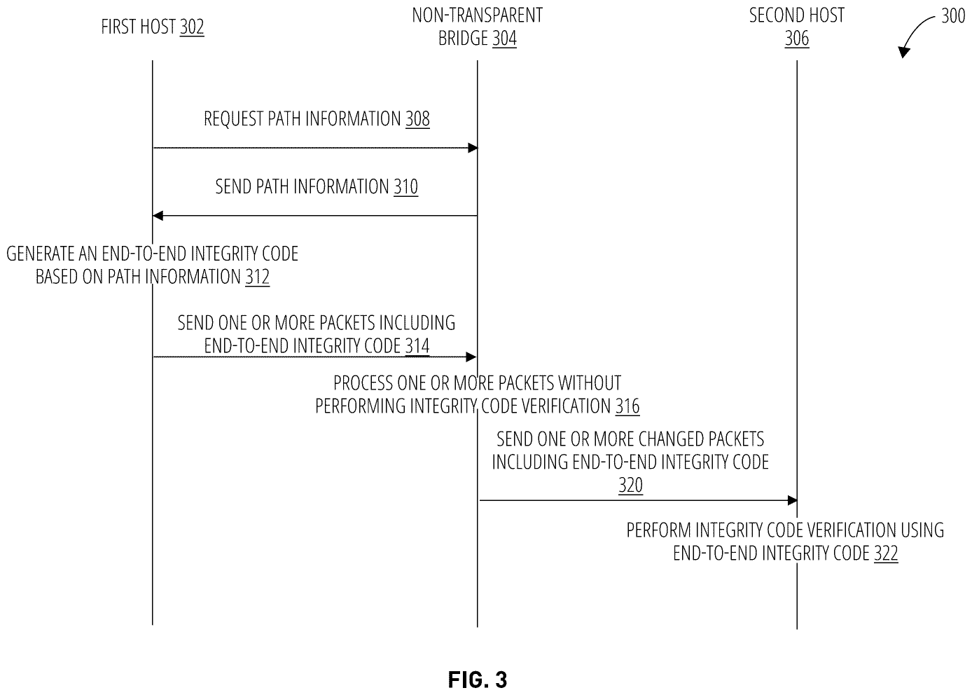

FIG. 3 is a swim-lane diagram depicting a process 300 to provide packet integrity protection across different PCIe domains connected (e.g., interfaced, without limitation) by an NTB (e.g., bridged by a PCIe switch in NTB mode, without limitation), in accordance with one or more examples. In this example, an end-to-end integrity code protects the entire communication path.

Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

The system that performs process 300 depicted by FIG. 3 includes a first host 302, an NTB 304, and a second host 306. In one or more examples, first host 302 and second host 306 may be, as non-limiting examples, host devices, or root complex logic of host devices, without limitation. In one or more examples, NTB 304 may be a PCIe switch operating in NTB mode. NTB 304 divides the network into two domains: a first domain that includes the first host 302 and the NTB 304, and a second domain that includes the NTB 304 and the second host 306. In process 300, NTB 304 does not perform integrity code verification so the first host 302 generates a single an end-to-end integrity code to protect the entire communication path between first host 302 and second host 306, which includes the first path segment between the first host 302 and the NTB 304 and a second path segment between the NTB 304 and the second host 306. Thus the first path segment, the second path segment, and the communication path that includes the first path segment and the second path segment, are protected by the end-to-end integrity code.

In one or more examples, process 300 may include first host 302 requesting path information from NTB 304 at operation 308.

In one or more examples, process 300 may include NTB 304 sending path information to first host 302 at operation 310.

In one or more examples, process 300 may include first host 302 generating an end-to-end integrity code at least partially based on path information received from the NTB 104 at operation 312.

In one or more examples, process 300 may include first host 302 sending one or more packets including the end-to-end integrity code to NTB 304 at operation 314.

In one or more examples, process 300 may include the NTB 104 processing the one or more packets without performing integrity code verification at operation 316. The NTB 104 may modify the packet to ensure proper delivery between domains, as discussed herein.

In one or more examples, process 300 may include NTB 304 sending one or more packets—which include the end-to-end integrity code—to second host 306 at operation 320. As discussed, above, the packet sent by NTB 304 in operation 320 is a modified packet, where integrity-protected portions have been changed as required (e.g., to reflect address translation or routing information, without limitation). The modifications to the integrity-protected portions are performed by the NTB 304 based on its routing logic, and these changes should align with the determination made by the first host 302 based on which it generated the second integrity code.

In one or more examples, process 300 may include second host 306 performing integrity code verification using the end-to-end integrity code at operation 322.

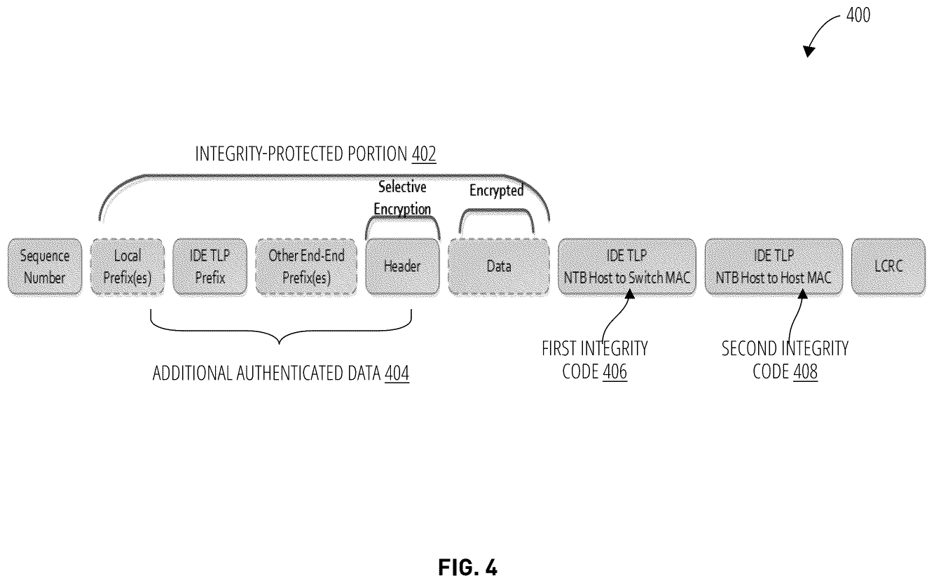

FIG. 4 is a schematic diagram of a packet structure 400 that includes a field (or subfield) for a first integrity code and a field (or subfield) for a second integrity code, in accordance with one or more examples. Packet structure 400 is a non-limiting example of a packet structure of a packet transmitted in process 100 or process 200, discussed above.

Packet structure 400 includes fields for: sequence numbers, local prefixes, IDE transaction layer packet structure (TLP) prefixes, other end-to-end prefixes, header, data, first integrity code (“IDE TLP NTB Host to Switch MAC”), second integrity code (“IDE TLP NTB Host to Host MAC”), and Link Cyclic Redundancy Check (LCRC).

In one or more examples, fields for first integrity code and second integrity code may be specified in a standard. Alternatively, a field for first integrity code may be specified in a standard and a field for second integrity code may be a field, or element thereof, for storing custom data (e.g., a reserved field or element, such as a field or element for storing vendor specific information, without limitation). In one or more examples, the field for the second integrity code may be a standard field (i.e., specified in a standard). In one or more examples, the field for the second integrity code may be non-standard (not specified in a standard) and so a reserved field (e.g., reserved field specified by the standard) may be utilized.

The field for a sequence number is used in a Data Link Layer Packet (DLLP) for ensuring reliable data transmission in PCIe. It helps in identifying and managing the order of TLPs (Transaction Layer Packets), flow control, and error handling.

Fields for local prefixes are used to store information local to a link, and such information may be used, as non-limiting examples, for link-level flow control or other link-specific features or enhancements.

The field for TLP prefix, including the ID-based Enumeration (IDE) TLP prefix, is a mechanism to add additional information to the Transaction Layer Packets (TLP), TLP's are packets used in a PCIe request-response protocol, such as a request to read data from a specific memory address, and delivering the requested data in response, without limitation. The TLP prefix information may be used to extend the functionality of a TLP. An IDE TLP prefix, specifically, is used to enhance routing capabilities.

The field for other end-to-end prefixes is used to store information that is not just local to a link, and so intended to be transmitted across an entire PCIe fabric from a sender to a receiver. Information stored the field for other end-to-end prefixes depends on specific operating conditions, and may include error checking information (e.g., End-to-End Cyclic Redundancy Check (ECRC), without limitation), routing information, or other purposes that depend on visibility across an entire PCIe path.

The field for a packet header (“Header”) includes several subfields:
a type subfield for indicating the type of packet (e.g., memory read, memory write, I/O read, I/O write, configuration read/write, without limitation);
a length subfield for indicating the length of packet structure 400;
a requestor Identifier (ID) subfield for specifying an identifier of the device that originated the packet;
a tag subfield for matching a response with a corresponding request.
an address subfield (or other specific data subfield) for memory and input/output (I/O) operations, that specifies the address being accessed. For configuration packets, this subfield may contain specific configuration data.

The field for the data payload (“Data”), which is an optional field, is for storing a payload of the packet. The data field would be present, as a non-limiting example, if packet structure 400 is carrying data, such as in memory write transactions, without limitation. The size (number of bits) of a data field and data varies depends on operating conditions, such as the transaction and the configuration of the PCIe devices, without limitation.

The field 406 for the first integrity code and the field 408 for the second integrity code store information used for authentication and data integrity assurances. Specifically, the information assures that message came from a specific, authenticated source and has not changed during transmission, as discussed herein. Specifically, the first integrity code provide assurances for a host-to-switch segment of a communication path (the first path segment between first host and PCIe switch in NTB mode), and the second integrity code provides assurances for a switch-to-host segment of a communication path (the second path segment between PCIe switch in NTB mode and second host). The assurances provided by the first and second integrity code apply to the integrity-protected portion 402 of packet structure 400. In the specific example depicted by FIG. 4, the integrity-protected portion 402 of packet structure 400 includes fields for the data, and fields 404 for additional authenticated data including one or more of: IDE TLP prefix, other end-to-end prefixes, and at least some subfields of the header field.

The field for an error detecting code is used for error checking local to a PCIe link, such as a Link Cyclic Redundancy Check (LCRC), without limitation. Error checking is used to ensure that the data payload and some or a totality of a header have not changed (e.g., corrupted, without limitation) during transmission over the PCIe link.

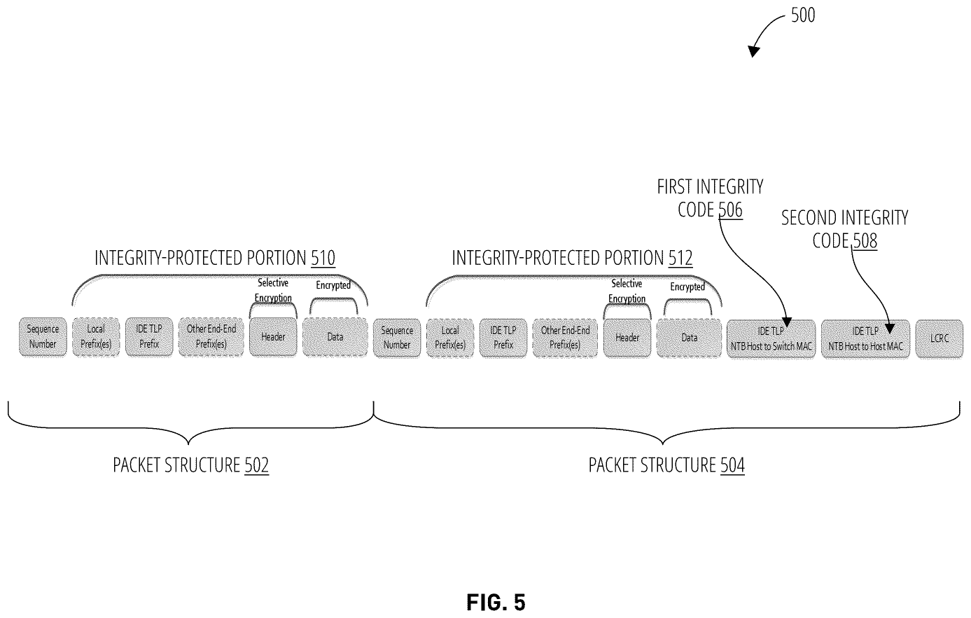

FIG. 5 is a schematic diagram of a packet stream structure 500 that includes fields for a first integrity code and a second integrity code utilized to protect information in the integrity-protected portions of multiple packets in sequence (e.g., a stream, without limitation), in accordance with one or more examples.

Packet stream structure 500 includes a first packet structure 504 that includes a field 506 for a first integrity code (“IDE TLP NTB Host to Switch MAC”) and a field 508 for a second integrity code (“IDE TLP NTB Host to Host MAC”), and a second packet structure 502 that does not include any fields for integrity codes (nor for a LCRC)—at least not for the integrity-protected portion 510 and integrity-protected portion 512. The first integrity code and second integrity code included in the fields 506 and field 508 of packet structure 504 protect the integrity of the integrity-protected portion 510 of packet structure 502 and the integrity-protected portion 512 of packet structure 504.

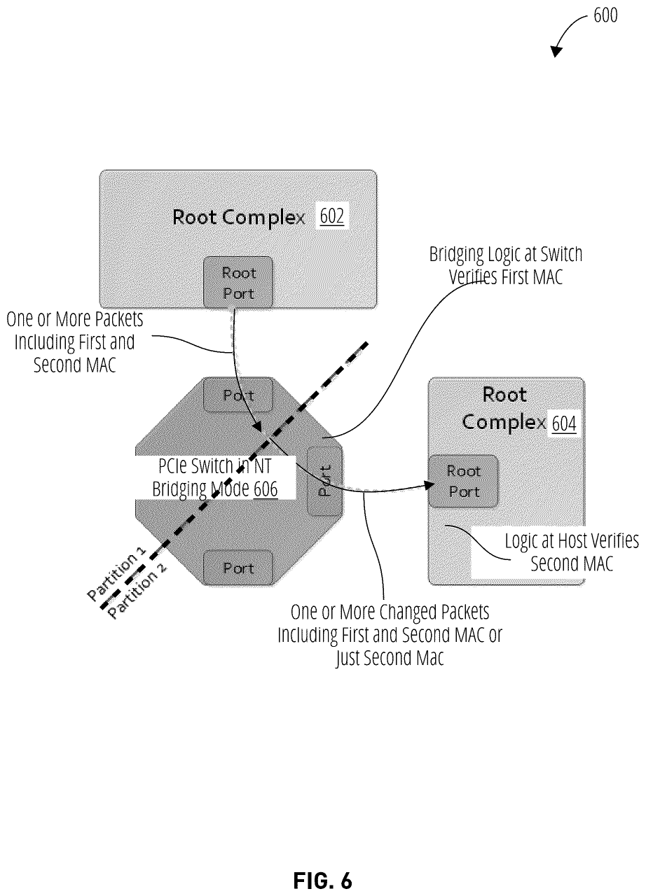

FIG. 6 is a schematic diagram of a system 600 for providing packet integrity protection of a communication path that includes an NTB, in accordance with one or more examples.

System 600 includes root complex 602, root complex 604 and PCIe switch 606 in non-transparent bridging mode. Respective domains of root complex 602 and root complex 604 are connected by PCIe switch 606. A communication path between root complex 602 and root complex 604 includes PCIe switch 606.

A root complex serves as the interface between the host CPU and PCIe devices. The root complex is the “root” of the PCIe tree where all PCIe devices (sensors, graphics cards, network cards, storage devices, data buses, without limitation) are connected. The root complex acts as an interface between a CPU and PCIe devices. For example, the root complex manages communication between a CPU and PCIe devices.

A root complex (e.g., root complex 602 or root complex 604, without limitation) includes one or more PCIe ports which may be connected to PCIe endpoints (devices) or downstream switches (e.g., PCIe switch 606, without limitation).

In one or more examples, a root complex (e.g., root complex 602 or root complex 604, without limitation) may have its own processing core or be integrated into a chipset or a CPU.

In a non-transparent bridge mode, PCIe switch 606 may be divided into two or more, separate virtual switch partitions (respective virtual switch partitions a “partition”). Respective partitions have their own USP and zero or more downstream ports, which allows PCIe switch 606 to be connected to multiple root complexes. A respective RC is aware of the devices in its PCIe partition.

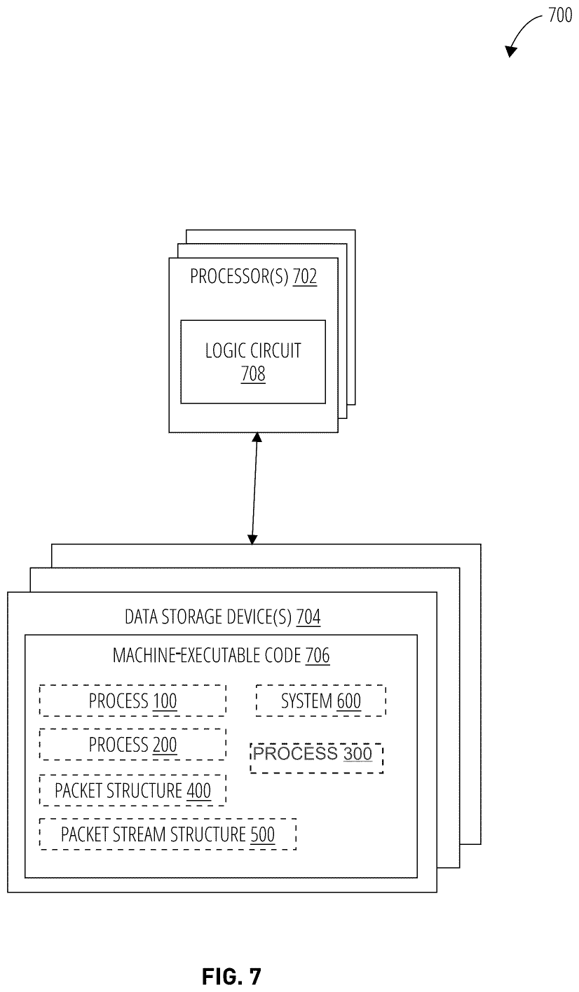

It will be appreciated by those of ordinary skill in the art that functional elements of examples disclosed herein (e.g., functions, operations, acts, processes, or methods) may be implemented in any suitable hardware, software, firmware, or combinations thereof. FIG. 7 illustrates non-limiting examples of implementations of functional elements disclosed herein. In some examples, some or all portions of the functional elements disclosed herein may be performed by hardware capable of carrying out the functional elements.

FIG. 7 is a block diagram of a circuitry 700 that, in some examples, may be used to implement various functions, operations, acts, processes, or methods disclosed herein. The circuitry 700 includes one or more processors 702 (sometimes referred to herein as “processors 702”) operably coupled to one or more data storage devices 704 (sometimes referred to herein as “storage 704”). The storage 704 includes machine-executable code 706 stored thereon and the processors 702 include logic circuit 708. The machine-executable code 706 includes information describing functional elements that may be implemented by (e.g., performed by) the logic circuit 708. The logic circuit 708 is adapted to implement (e.g., perform) the functional elements described by the machine-executable code 706. The circuitry 700, when executing the functional elements described by the machine-executable code 706, should be considered as special purpose hardware for carrying out functional elements disclosed herein. In one or more examples, the processors 702 may perform the functional elements described by the machine-executable code 706 sequentially, concurrently (e.g., on one or more different hardware platforms), or in one or more parallel process streams.

When implemented by logic circuit 708 of the processors 702, the machine-executable code 706 adapts the processors 702 to perform operations of examples disclosed herein. By way of non-limiting example, the machine-executable code 706 may adapt the processors 702 to perform some or a totality of operations of one or more of: process 100 or process 200.

Also by way of non-limiting example, the machine-executable code 706 may adapt the processors 702 to perform some or a totality of features, functions, or operations disclosed herein for one or more of: first host 102, NTB 104, second host 106, first host 202, NTB 204, second host 206, packet structure 400, packet stream structure 500, or system 600.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 702, including a general-purpose processor, is considered a special-purpose computer at least while the general-purpose computer executes functional elements corresponding to the machine-executable code 706 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 702 may include any conventional processor, controller, microcontroller, or state-machine. An FPGA or other PLD of the processors 702 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 702 may also be implemented as a combination of computing devices, such as a combination of a DSP and a microprocessor, a plurality of microprocessors, one or more microprocessors in conjunction with a DSP core, or any other such configuration.

In one or more examples the storage 704 includes volatile data storage (e.g., volatile memory such as random-access memory (RAM), static RAM (SRAM), without limitation), non-volatile data storage (e.g., non-volatile memory such as Flash memory, a hard disc drive, a solid state drive, erasable programmable read-only memory (EPROM), without limitation). In some examples the processors 702 and the storage 704 may be implemented into a single device (e.g., a semiconductor device product, a system on chip (SOC), without limitation). In some examples the processors 702 and the storage 704 may be implemented into separate devices.

In one or more examples the machine-executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also by way of non-limiting example, the computer-readable instructions may be stored on the storage 704, transferred to a memory device (not shown) for execution, and executed by the processors 702 using at least the logic circuit 708. Processors 702 or logic circuit 708 thereof be coupled to such a memory device or include such a memory device (e.g., a configuration memory cell, without limitation). Accordingly, in some examples the logic circuit 708 includes electrically configurable logic circuit 708.

In one or more examples the machine-executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 706 may include an HDL, an RTL, a GL description, a mask level description, other hardware description, or any combination thereof.

In examples where the machine-executable code 706 includes a hardware description (at any level of abstraction), a system (not shown, but including the storage 704) implements the hardware description described by the machine-executable code 706. By way of non-limiting example, the processors 702 may include a programmable logic device (e.g., an FPGA or a PLC, without limitation) and the logic circuit 708 may be electrically controlled (e.g., via configuration data, without limitation) to implement circuitry corresponding to the hardware description into the logic circuit 708. Also by way of non-limiting example, the logic circuit 708 may include hard-wired logic manufactured by a manufacturing system (not shown, but including the storage 704) according to the hardware description of the machine-executable code 706.

Regardless of whether the machine-executable code 706 includes computer-readable instructions or a hardware description, the logic circuit 708 is adapted to perform the functional elements described by the machine-executable code 706 when implementing the functional elements of the machine-executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method comprising: protecting integrity of a first segment of a communication path across different Peripheral Component Interconnect Express (“PCIe”) domains with a first integrity code, the different PCIe domains connected by a non-transparent bridge (“NTB”); and protecting integrity of a second segment of the communication path with a second integrity code, wherein the second integrity code is different than the first Message Authentication Code (“MAC”).

Example 2: The method according to Example 1, comprising: defining the first segment of the communication path to be between an originating host and a PCIe switch in non-transparent bridge mode; and defining the second segment of the communication path to be between the PCIe switch in non-transparent bridge mode and a destination host.

Example 3: The method according to any of Examples 1 and 2, comprising: generating the first integrity code based on an integrity-protected portion of a packet; and generating the second integrity code based on expected modifications to the integrity-protected portion of the packet.

Example 4: The method according to any of Examples 1 through 3, comprising: determining the expected modifications to the integrity-protected portion of the packet at least partially based on path information received from the NTB.

Example 5: The method according to any of Examples 1 through 4, comprising: receiving path information from the NTB, the path information comprising path information indicating modifications to an integrity-protected portion of a packet.

Example 6: The method according to any of Examples 1 through 5, comprising: receiving a packet with a first integrity code and a second integrity code; verifying the first integrity code; modifying an integrity-protected portion of the packet; and sending the modified packet including the second integrity code.

Example 7: The method according to any of Examples 1 through 6, comprising: upon verifying the first integrity code writing the second integrity code to a field of the packet for an integrity code protecting an integrity-protected portion of the packet.

Example 8: The method according to any of Examples 1 through 7, wherein writing the second integrity code to the field comprises overwriting the first integrity code with the second integrity code.

Example 9: The method according to any of Examples 1 through 8, comprising: writing the first integrity code to a first field of a packet, and writing the second integrity code to a second field of the packet, wherein the first field is a standard field for storing codes to protect integrity of a PCIe packet, and wherein the second field is a reserved field.

Example 10: A system, comprising: a first host of a first Peripheral Component Interconnect Express (“PCIe”) domain; a second host of a second PCIe domain; and a non-transparent bridge (“NTB”) connecting the first PCIe domain and the second PCIe domain, wherein integrity of a first segment of a communication path between the first host and the second host is protectable with a first integrity code, and a second segment of the communication path is protectable with a second integrity code, the second integrity code different than the first integrity code.

Example 11: The system according to Example 10, wherein: the first segment of the communication path defined between the first host and a PCIe switch in non-transparent bridge mode; and the second segment of the communication path defined between the PCIe switch in non-transparent bridge mode and the second host.

Example 12: The system according to any of Examples 10 and 11, wherein the first host to: generate the first integrity code based on an integrity-protected portion of a packet; and generate the second integrity code based on expected modifications to the integrity-protected portion of the packet.

Example 13: The system according to any of Examples 10 through 12, wherein the first host to: write the first integrity code to a first field of a packet, and write the second integrity code to a second field of the packet, wherein the first field is a standard field for storing codes to protect integrity of a PCIe packet, and wherein the second field is a reserved field.

Example 14: The system according to any of Examples 10 through 13, wherein a first device to: determine the expected modifications to the integrity-protected portion of the packet at least partially based on path information received from the NTB.

Example 15: The system according to any of Examples 10 through 14, wherein the first host to: receive path information from the NTB, the path information comprising path information indicating modifications to an integrity-protected portion of a packet.

Example 16: The system according to any of Examples 10 through 15, wherein the NTB to: receive a packet with a first integrity code and a second integrity code; verify the first integrity code; modify an integrity-protected portion of the packet; and send the modified packet including the second integrity code.

Example 17: The system according to any of Examples 10 through 16, wherein the NTB to: upon verification of the first integrity code write the second integrity code to a field of the packet for an integrity code protecting an integrity-protected portion of the packet.

Example 18: The system according to any of Examples 10 through 17, wherein the NTB to: overwrite the first integrity code with the second integrity code to write the second integrity code to the field.

Example 19: The system according to any of Examples 10 through 18, wherein the second host to: receive a packet including a same integrity code in a first field and a second field of the packet, wherein the first field is a standard field for storing an integrity code for protecting integrity of a PCIe packet, and wherein the second field is a reserved field; read the second integrity code from the first field of the packet; and verifying the second integrity code.

Example 20: The system according to any of Examples 10 through 19, wherein the second host to: receive a packet including the first integrity code in a first field and the second integrity code in a second field of the packet, wherein the first field is a standard field for storing an integrity code for protecting integrity of a PCIe packet, and wherein the second field is a reserved field; read the second integrity code from the second field of the packet; and verify the second integrity code.

Example 21: A method comprising: protecting integrity of a first segment of a communication path across different Peripheral Component Interconnect Express (“PCIe”) domains with an end-to-end integrity code, the different PCIe domains connected by a non-transparent bridge (“NTB”); and protecting integrity of a second segment of the communication path with the end-to-end integrity code.

Example 22: The method according to Example 21, comprising: generating the end-to-end integrity code based on expected modifications to an integrity-protected portion of a packet.

Example 23: The method according to any of Examples 21 and 22, comprising: determining the expected modifications to the integrity-protected portion of the packet at least partially based on path information received from the NTB.

Example 24: The method according to any of Examples 21 through 23, comprising: defining the first segment of the communication path between a first host and a PCIe switch in non-transparent bridge mode; and defining the second segment of the communication path between the PCIe switch in non-transparent bridge mode and a second host.

Example 25: A system, comprising: a first host of a first Peripheral Component Interconnect Express (“PCIe”) domain; a second host of a second PCIe domain; and a non-transparent bridge (“NTB”) connecting the first PCIe domain and the second PCIe domain, wherein integrity of a first segment of a communication path between the first host and the second host protectable with an end-to-end integrity code, and integrity of a second segment of the communication path protectable with the end-to-end integrity code.

Example 26: The system according to Example 25, wherein the first host to: generate the end-to-end integrity code based on expected modifications to the integrity-protected portion of the packet.

Example 27: The system according to any of Examples 25 and 26, wherein a first device to: determine the expected modifications to the integrity-protected portion of the packet at least partially based on path information received from the NTB.

Example 28: The system according to any of Examples 25 through 27, wherein: the first segment of the communication path defined between the first host and a PCIe switch in non-transparent bridge mode; and the second segment of the communication path defined between the PCIe switch in non-transparent bridge mode and the second host.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
protecting integrity of a first segment of a communication path across different Peripheral Component Interconnect Express (“PCIe”) domains with a first integrity code, the different PCIe domains connected by a non-transparent bridge (“NTB”); and
protecting integrity of a second segment of the communication path with a second integrity code, wherein the second integrity code is different than the first Message Authentication Code (“MAC”).

2. The method of claim 1, comprising:
defining the first segment of the communication path to be between an originating host and a PCIe switch in non-transparent bridge mode; and
defining the second segment of the communication path to be between the PCIe switch in non-transparent bridge mode and a destination host.

3. The method of claim 1, comprising:
generating the first integrity code based on an integrity-protected portion of a packet; and
generating the second integrity code based on expected modifications to the integrity-protected portion of the packet.

4. The method of claim 3, comprising:
determining the expected modifications to the integrity-protected portion of the packet at least partially based on path information received from the NTB.

5. The method of claim 4, comprising:
receiving path information from the NTB, the path information comprising path information indicating modifications to an integrity-protected portion of a packet.

6. The method of claim 1, comprising:
receiving a packet with a first integrity code and a second integrity code;
verifying the first integrity code;
modifying an integrity-protected portion of the packet; and
sending the modified packet including the second integrity code.

7. The method of claim 6, comprising:
upon verifying the first integrity code writing the second integrity code to a field of the packet for an integrity code protecting an integrity-protected portion of the packet.

8. The method of claim 7, wherein writing the second integrity code to the field comprises overwriting the first integrity code with the second integrity code.

9. The method of claim 6, comprising:
writing the first integrity code to a first field of a packet, and writing the second integrity code to a second field of the packet, wherein the first field is a standard field for storing codes to protect integrity of a PCIe packet, and wherein the second field is a reserved field.

10. A system, comprising:
a first host of a first Peripheral Component Interconnect Express (“PCIe”) domain;
a second host of a second PCIe domain; and
a non-transparent bridge (“NTB”) connecting the first PCIe domain and the second PCIe domain, wherein integrity of a first segment of a communication path between the first host and the second host is protectable with a first integrity code, and a second segment of the communication path is protectable with a second integrity code, the second integrity code different than the first integrity code.

11. The system of claim 10, wherein:
the first segment of the communication path defined between the first host and a PCIe switch in non-transparent bridge mode; and
the second segment of the communication path defined between the PCIe switch in non-transparent bridge mode and the second host.

12. The system of claim 10, wherein the first host to:
generate the first integrity code based on an integrity-protected portion of a packet; and
generate the second integrity code based on expected modifications to the integrity-protected portion of the packet.

13. The system of claim 12, wherein the first host to:
write the first integrity code to a first field of a packet, and write the second integrity code to a second field of the packet, wherein the first field is a standard field for storing codes to protect integrity of a PCIe packet, and wherein the second field is a reserved field.

14. The system of claim 12, wherein a first device to:
determine the expected modifications to the integrity-protected portion of the packet at least partially based on path information received from the NTB.

15. The system of claim 14, wherein the first host to:
receive path information from the NTB, the path information comprising path information indicating modifications to an integrity-protected portion of a packet.

16. The system of claim 10, wherein the NTB to:
receive a packet with a first integrity code and a second integrity code;
verify the first integrity code;
modify an integrity-protected portion of the packet; and
send the modified packet including the second integrity code.

17. The system of claim 16, wherein the NTB to:
upon verification of the first integrity code write the second integrity code to a field of the packet for an integrity code protecting an integrity-protected portion of the packet.

18. The system of claim 17, wherein the NTB to:
overwrite the first integrity code with the second integrity code to write the second integrity code to the field.

19. The system of claim 10, wherein the second host to:
receive a packet including a same integrity code in a first field and a second field of the packet, wherein the first field is a standard field for storing an integrity code for protecting integrity of a PCIe packet, and wherein the second field is a reserved field;
read the second integrity code from the first field of the packet; and
verifying the second integrity code.

20. The system of claim 10, wherein the second host to:
receive a packet including the first integrity code in a first field and the second integrity code in a second field of the packet, wherein the first field is a standard field for storing an integrity code for protecting integrity of a PCIe packet, and wherein the second field is a reserved field;
read the second integrity code from the second field of the packet; and
verify the second integrity code.

21. A method comprising:
protecting integrity of a first segment of a communication path across different Peripheral Component Interconnect Express (“PCIe”) domains with an end-to-end integrity code, the different PCIe domains connected by a non-transparent bridge (“NTB”); and
protecting integrity of a second segment of the communication path with the end-to-end integrity code.

22. The method of claim 21, comprising:
generating the end-to-end integrity code based on expected modifications to an integrity-protected portion of a packet.

23. The method of claim 22, comprising:
determining the expected modifications to the integrity-protected portion of the packet at least partially based on path information received from the NTB.

24. The method of claim 21, comprising:
defining the first segment of the communication path between a first host and a PCIe switch in non-transparent bridge mode; and
defining the second segment of the communication path between the PCIe switch in non-transparent bridge mode and a second host.

25. A system, comprising:
a first host of a first Peripheral Component Interconnect Express (“PCIe”) domain;
a second host of a second PCIe domain; and
a non-transparent bridge (“NTB”) connecting the first PCIe domain and the second PCIe domain, wherein integrity of a first segment of a communication path between the first host and the second host protectable with an end-to-end integrity code, and integrity of a second segment of the communication path protectable with the end-to-end integrity code.

26. The system of claim 25, wherein the first host to:
generate the end-to-end integrity code based on expected modifications to the integrity-protected portion of the packet.

27. The system of claim 26, wherein a first device to:
determine the expected modifications to the integrity-protected portion of the packet at least partially based on path information received from the NTB.

28. The system of claim 25, wherein:
the first segment of the communication path defined between the first host and a PCIe switch in non-transparent bridge mode; and
the second segment of the communication path defined between the PCIe switch in non-transparent bridge mode and the second host.
